(19) United States
(12) Patent Application Publication
(10) Pub. No.: US 2008/0204704 A1
(43) Pub. Date: Aug. 28, 2008

(54) Monitoring System And Method For Determining The Speed And/Or Angle Of Motion Of An Object

(75) Inventors: David B. Rankin, Winston-Salem, NC (US); Mark D. Reasor, Winston-Salem, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: AccuSport International, Inc.

(21) Appl. No.: 12/020,358

(22) Filed: Jan. 25, 2008

Related U.S. Application Data
(60) Provisional application No. 60/886,593, filed on Jan. 25, 2007.

(51) Int. Cl. G01P 3/36

(52) U.S. Cl. 356/28

(57) ABSTRACT

A monitoring system and associated method are provided to determine various parameters, such as the speed and/or angle of motion, of an object. The monitoring system includes a phototransmitter for illuminating the space through which the object will pass. The monitoring system also includes a plurality of photoreceivers spaced apart from one another with each photoreceiver including a plurality of receiver elements. The monitoring system further includes a controller to analyze output signals provided by the receiver elements and to detect the object in relation to a respective photoreceiver based upon differences between the output signals provided by the receiver elements of the respective photoreceiver. The controller is also configured to determine a parameter associated with the flight of the object, such as the speed and/or angle of motion of the object, based upon detection of the object in relation to each of a plurality of the photoreceivers.

### CROSS REFERENCE TO A RELATED APPLICATION

The present application claims priority to U.S. Provisional Application No. 60/886,593 entitled “Monitoring System and Method for Determining the Speed and/or Angle of Motion of an Object” and filed Jan. 25, 2007, the contents of which are incorporated in their entirety by reference.

### FIELD OF THE INVENTION

Embodiments of the present invention relate generally to techniques for measuring the launch conditions or other parameters of a golf ball or other object in motion and, more particularly, to techniques for determining the speed and/or launch angle of a golf ball or other object.

### BACKGROUND OF THE INVENTION

Many golfers work consistently to improve their game. One tool that has been developed to assist golfers in analyzing their golf shots is a golf ball launch monitor. Golf ball launch monitors are used extensively to provide detailed information regarding the velocity of the ball, the launch angle of the ball, the side spin of the ball and the like. As such, golf ball launch monitors are quite useful in training sessions to evidence the manner in which swing changes affect the resulting golf shots. Similarly, launch monitors are quite useful in club fitting to provide feedback on the golf shots hit by a golfer with different clubs such that the golfer can more intelligently select the most suitable set of clubs for the game. Further details regarding launch monitors are provided by U.S. patent application Ser. No. 10/360,196 filed Feb. 7, 2003, entitled “Methods Apparatus and Computer Program Products for Processing Images of Golf Balls”, the contents of which are incorporated herein in their entirety.

Various types of launch monitors have been developed that rely upon different technologies to capture information regarding the launch conditions of a golf ball. One type of launch monitor captures two, successive images of a golf ball shortly after the golf ball has been struck. By comparing the images, parameters relating to the velocity of the ball, launch angle of the ball, side spin of the ball and the like can be determined as described by the '196 application. While launch monitors that capture and analyze images of a golf ball to determine various launch parameters have proven to be quite successful, it would be desirable in some applications to be able to provide or utilize a less costly launch monitor even if the launch monitor did not offer the same precision or was otherwise not as robust as launch monitors that capture and analyze images of a golf ball. Even if an application could sacrifice some precision and/or robustness for cost savings, most applications would still demand a fair degree of accuracy, reliability and repeatability.

Accordingly, it would also be desirable to provide a monitor that can reliably determine the speed and/or angle of motion of a golf ball or other object in a more economical manner than generally afforded by conventional launch monitors.

### SUMMARY OF THE INVENTION

A monitoring system and associated method are therefore provided which address at least some of the issues associated with conventional launch monitors. In particular, the monitoring system and method of one embodiment can reliably determine the speed and/or angle of motion of a golf ball or other object in an economical manner.

In one embodiment, a monitoring system is provided which includes a phototransmitter for providing illumination of a portion of a space through which an object will pass. The monitoring system of this embodiment also includes a plurality of photoreceivers spaced apart from one another. Each photoreceiver generally includes a plurality of receiver elements. Additionally, the phototransmitter and the plurality of photoreceivers are configured to establish a respective light curtain with each photoreceiver. The monitoring system also includes a triggering mechanism configured to cause the phototransmitter to provide the illumination in response to a predefined triggering event. The monitoring system of this embodiment further includes a controller configured to analyze output signals provided by the receiver elements of the plurality of photoreceivers and to detect the object in relation to a respective photoreceiver based upon the output signals provided by the receiver elements of the respective photoreceiver. The controller is also configured to determine a parameter associated with the flight of the object through the space, such as the speed and/or angle of motion of the object, based upon detection of the object in relation to each of a plurality of the photoreceivers.

The monitoring system may include a plurality of phototransmitters spaced apart from one another. In this embodiment, each photoreceiver is paired with and illuminated by a different respective phototransmitter, thereby establishing a light curtain between the paired phototransmitter and photoreceiver. The monitoring system of one embodiment may also include a housing in which the plurality of photoreceivers are disposed in a recessed manner.

The triggering mechanism may include a high pass filter. In one embodiment, the phototransmitter may also cease to provide the illumination following the lapse of a predetermined amount of time from the predefined triggering event.

The controller may also be configured to determine a difference in time at which the object is detected in relation to different ones of the plurality of photoreceivers. The controller may be further configured to ignore the output signals provided by the receiver elements of the respective photoreceiver that fail to satisfy a predefined threshold.

The monitoring system may include a housing in which the phototransmitter is disposed. In this regard, the phototransmitter may include a plurality of illumination elements recessed within the housing. In one embodiment, the monitoring system includes an illumination component including a housing and the phototransmitter disposed within the housing and a reception component including a housing and the plurality of photoreceivers disposed within the housing. In this embodiment, the illumination component and the reception component are configured to be spaced apart from one another such that the object will pass therebetween. As such, the controller of this embodiment is configured to detect the object in relation to a respective photoreceiver based upon a shadow created by the object upon one or more receiver elements of the respective photoreceiver. In another embodiment, the monitoring system may include a housing in which the phototransmitter and the plurality of photoreceivers are disposed. As such, the controller of this embodiment is configured to detect the object in relation to a respective photoreceiver based upon light reflected from the object that is captured by one or more receiver elements of the respective photoreceiver. In accordance with another embodiment, a method is provided which includes illuminating a portion of a space through which an object will pass and detecting light with each of a plurality of spaced apart photoreceivers. In this regard, the illumination is initiated in response to a predefined triggering event. In addition, detecting light with a photoreceiver includes detecting light with a plurality of receiver elements that comprise the photoreceiver. As a result of the illumination and the detection, a plurality of light curtains are established with a respective light curtain associated with each photoreceiver. The method also includes detecting the object in relation to a respective photoreceiver based upon output signals provided by the receiver elements of the respective photoreceiver. The method further includes determining a parameter associated with a flight of the object through the space based upon detection of the object in relation to each of a plurality of the photoreceivers.

In one embodiment, the light is detected with the plurality of photoreceivers which are recessed within a housing. The method may also include filtering the audible signals prior to initiating illumination. Additionally, the method of this embodiment may cease the illumination following lapse of a predetermined amount of time from the predefined triggering event.

In various embodiments, the method may also determine a difference in time at which the object is detected in relation to different ones of the plurality of photoreceivers. In conjunction with detecting the object, the method may ignore the output signals provided by the receiver elements of the respective photoreceiver that fail to satisfy a predefined threshold.

The plurality of photoreceivers may be spaced from a source of illumination such that the object will pass therebetween. In this embodiment, the object may be detected in relation to a respective photoreceiver based upon a shadow created by the object upon one or more receiver elements of the respective photoreceiver. Alternatively, the plurality of photoreceivers may be positioned on the same side of the space as a source of illumination such that the object will pass to one side of both the plurality of photoreceivers and the source of illumination. In this embodiment, the object may be detected in relation to a respective photoreceiver based upon light reflected from the object that is captured by one or more receiver elements of the respective photoreceiver.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of a monitoring system according to one embodiment of the present invention;

FIG. 2 is a block diagram of a monitoring system according to one embodiment of the present invention;

FIG. 3 is a plan view of the illumination component of the monitoring system of FIG. 1;

FIG. 4 is a schematic representation of the shadowed phototransistors of first and second photoreceivers of one embodiment;

FIG. 5 is a graphical representation of the output signals provided by first and second photoreceivers of one embodiment;

FIG. 6 is a fragmentary plan view of a phototransmitter recessed within the housing of an illumination component according to one embodiment of the present invention; and

FIG. 7 is a fragmentary view of the phototransmitter of the illumination component taken along lines 7-7 of FIG. 6.

### DETAILED DESCRIPTION OF EMBODIMENTS OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

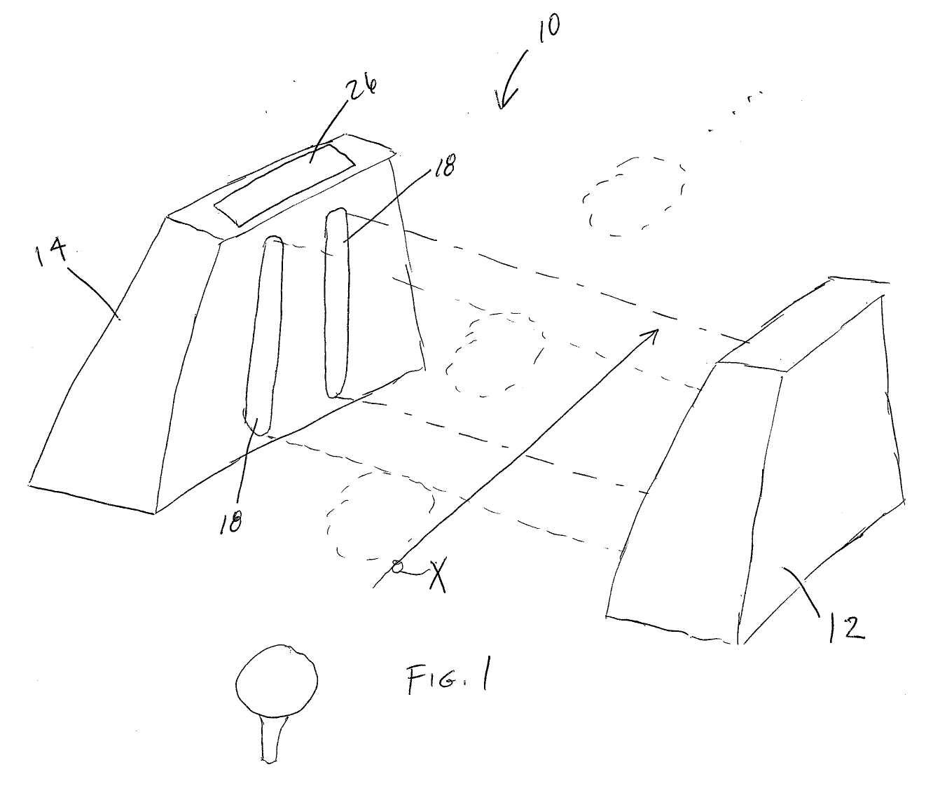

Referring now to FIG. 1, a monitoring system 10 of one advantageous embodiment of the present invention is depicted. While the monitoring system of another embodiment may operate in a reflective mode and include only a single component as described below, the embodiment of the monitoring system depicted in FIG. 1 operates in a transmissive mode and includes an illumination or transmission component 12 and a reception component 14, typically connected by a wired connection, such as an RJ45 cable, or a wireless connection. As shown, the components are positioned and are spaced apart from one another such that the anticipated path of the object to be imaged, such as the anticipated flight path of a golf ball following launch of the golf ball, passes between the components. In this regard, although the monitoring system 10 will be described as a launch monitor in conjunction with the determination of parameters associated with the launch of a golf ball, the monitoring system can be utilized to monitor a number of different objects including, for example, baseballs, softballs, tennis balls or the like, without departing from the spirit and scope of the present invention. In the exemplary application in which the monitoring system is utilized to determine the launch parameters of a golf shot, the components are generally positioned slightly forward of the ball at rest, such as slightly forward of the tee, and are spaced by a distance typically between about two feet and four feet, such as three feet in one exemplary embodiment.

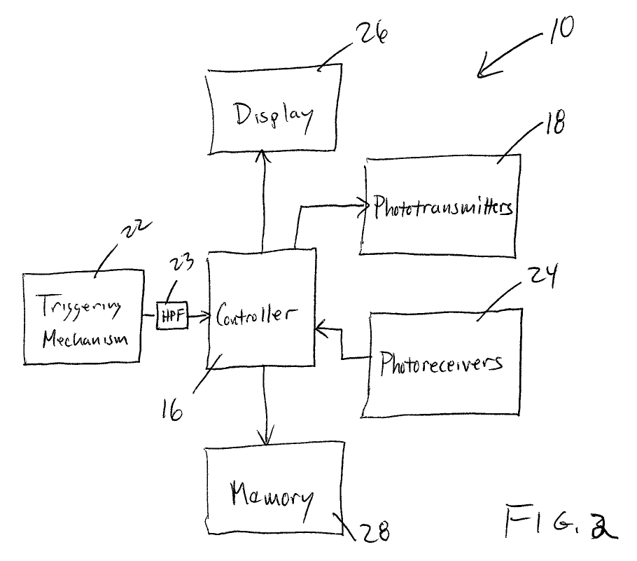

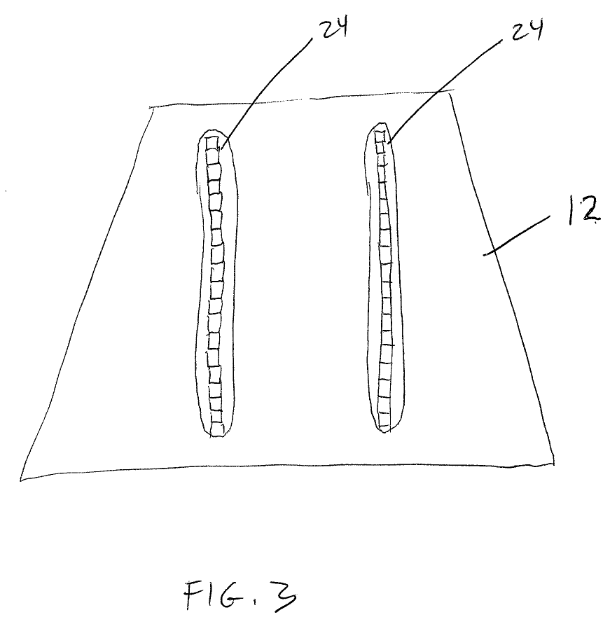

As shown in FIG. 2, the monitoring system includes and in general operates under the direction of a controller 16, such as a programmable system on chip (PSOC), microcontroller, microprocessor, application specific integrated circuit, field programmable gate array, personal computer or other computing system. Typically, the controller is disposed within the reception component 14, although the controller may alternatively be included within the illumination component 12 or may be external to both the illumination and reception components, if so desired. Additionally, the monitoring system and, in particular, the illumination component as shown more clearly in FIG. 3 includes a plurality of phototransmitters 18 operating under direction of the controller for illuminating a portion of the space between the illumination and reception components. The plurality of phototransmitters are spaced from one another in the direction in which the object will be passing therethrough. In the embodiment depicted in FIG. 1, for example, the phototransmitters are spaced from one another in the direction designated as X.

As shown by dashed lines in FIG. 1, the phototransmitters 18 can be spaced apart from one another by various distances. Typically, the spacing of the phototransmitters is sufficiently large such that the illumination provided by one phototransmitter only illuminates a single corresponding photoreceiver as described below and does not concurrently illuminate multiple adjacent photoreceivers. Subject to this consideration, the spacing between phototransmitters is otherwise generally reduced or minimized such that the resulting illumination component 12 can be made relatively compact. In one exemplary embodiment, adjacent phototransmitters are spaced apart by distance between 2 inches and 6 inches, such as 3 inches, in the direction designated as X. Additionally, the spacing between each adjacent pair of phototransmitters is typically identical, but the spacing between adjacent pairs of phototransmitters can be different, if so desired. In an embodiment that includes first, second and third phototransmitters, for example, the first and second phototransmitters can be spaced apart by x, while the second and third phototransmitters can be spaced apart by a distance of x+y.

Each phototransmitter 18 generally provides a relatively planer sheet of light, such as a light curtain, extending from the illumination component 12 toward the reception component 14. In this regard, the curtain of light is generally configured to define a plane extending between the illumination and reception components and extending generally upward or perpendicular to the surface, such as the ground, upon which the monitoring system 10 is positioned, such as schematically illustrated by the light curtain 20 in FIG. 1. The phototransmitters can be embodied in many different manners in order to provide the desired light curtain. In one embodiment, for example, each phototransmitter includes an array of light sources arranged in a generally linear fashion and oriented so as to extend upward or perpendicular to the surface upon which the monitoring system is positioned. In this regard, each phototransmitter may be comprised of a linear array of light emitting diodes (LEDs), such as high bright light emitting diodes that emit light in the near infrared spectrum, e.g., at 830 nanometers. While the linear array of LEDs may include only a single column as shown in FIG. 3, the linear array can include a plurality of columns, such as three columns, of LEDs oriented so as to extend upward or perpendicular to the surface upon which the monitoring system is positioned.

As noted above, the controller 16 typically drives each phototransmitter 18 so as to illuminate, i.e., emit light, at and for a predetermined time. Although the controller could drive the phototransmitters to illuminate in a sequential fashion as the object passes thereby, the controller typically simultaneously activates all of the phototransmitters and, following activation for a predefined period of time, such as 1 milliseconds, simultaneously deactivates all of the phototransmitters.

In order to correlate the illumination of the phototransmitters 18 with the launch of the object to be monitored, such as with the launch of the golf ball, the monitoring system 10 can also include a triggering mechanism 22, such as an optical trigger mechanism which detects movement of a golf club or golf ball past a particular point or an audible trigger mechanism which detects the sound created upon contact between the golf club and the golf ball. The triggering mechanism provides a trigger signal to the controller 16 which, in turn, directs all of the phototransmitters to simultaneously illuminate, thereby generating two or more light curtains through which the golf ball will pass. Typically, the phototransmitters provide illumination very quickly following generation of the trigger signal so as to detect quickly moving objects, such as golf balls. For example, the phototransmitters may provide illumination in response to direction by the controller within 250 μsec of the generation of the trigger signal.

The triggering mechanism 22 can also include a filter, such as a high pass filter 23, to remove frequency components that are not indicative of contact between the golf club and the golf ball, but that might otherwise erroneously cause a generation of a trigger signal. In this regard, it has been noted that certain golfers swing a golf club with a sufficient club head speed to accordingly displace air in advance of the club head which creates the compression wave having a relatively low frequency that may, in some instances, cause the triggering mechanism to generate a trigger signal in the absence of the high pass filter. The high pass filter may be designed for the particular application so as to pass signals having a frequency greater than predefined cutoff frequency with little or no attenuation, while blocking or attenuating signals having frequencies lower than the cutoff frequency. As such, the monitoring system 10 can operate reliably even in circumstances in which there is a significant amount of low frequency noise, such as that generated by the compression waves created by some golfers that have substantial club head speed.

As shown in FIG. 1, the reception component 14 includes a plurality of photoreceivers 24. Typically, the receiver component includes at least as many, and most commonly, the same number of photoreceivers as the illumination component 12 includes phototransmitters 18. Like the phototransmitters, the photoreceivers are spaced apart from one another in the direction, i.e., direction X, which the object to be monitored will pass through the monitoring system. The photoreceivers are generally positioned relative to the phototransmitters such that the light curtain generated by one phototransmitter will illuminate only a single respective photoreceiver. As such, the phototransmitters and photoreceivers are generally positioned in a pairwise relationship such that each phototransmitter illuminates and is therefore associated with a single photoreceiver. As such, the photoreceivers may be spaced apart by the same distances that the corresponding phototransmitters are spaced, such as 3 inches in one embodiment. As a result of the generation of a light curtain that is generally oriented to extend in a direction upward from or perpendicular to the surface on which the monitoring system 10 is positioned, each photoreceiver 24 is also typically comprised of an array of receiver elements, such as an array of phototransistors as will be discussed hereinafter by way of example, arranged in a linear fashion and similarly oriented so as to extend in a direction upward from or perpendicular to the surface on which the monitoring system is positioned. While the linear array of phototransistors may include only a single column, the linear array can include a plurality of columns, such as three columns, of phototransistors oriented so as to extend upward or perpendicular to the surface upon which the monitoring system is positioned.

In operation, the photoreceivers 24 are also activated by the controller 16 in response to the trigger signal such that the phototransistors of the photoreceivers detect or sense the intensity of the light incident thereupon, such as a result of the illumination by the corresponding phototransmitters 18, and, in turn, provide a voltage output representative of the intensity of the detected light. Typically, the voltage output is provided repeatedly or continuously over time so that changes in the detected light over time, such as generated by the passage of the ball through a respective light curtain, can be detected. Following a predefined period of time during which the phototransistors have been activated, such as for 1 millisecond following the trigger signal, the controller then deactivates the photoreceivers.

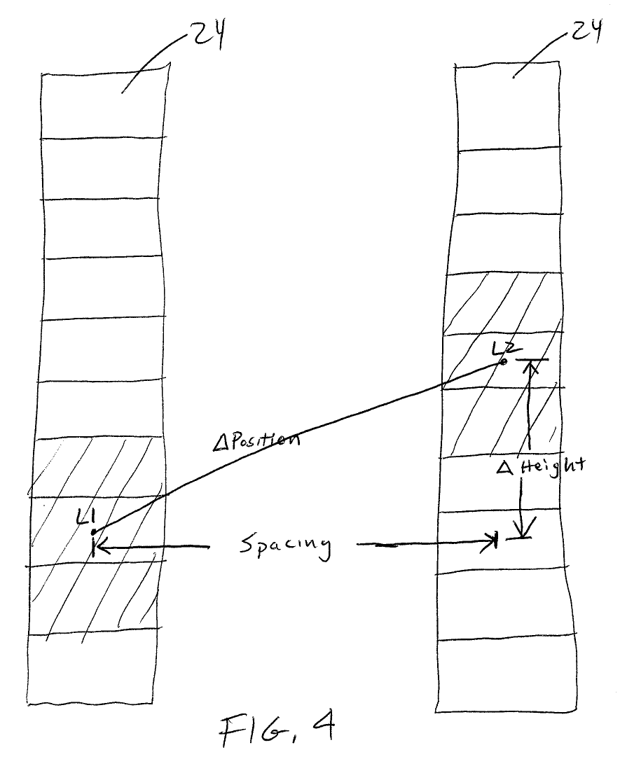

In the embodiment illustrated in FIG. 1 which is designed to operate in the transmission mode and in which each photoreceiver 24 includes a number of phototransistors, the object passing through the light curtain generated by a phototransmitter 18 will disperse, reflect or otherwise block the optical signals from reaching the phototransistors (i.e., the shadowed phototransistors) of the respective photoreceiver that are aligned with the object. As a result of the configuration of the monitoring system 10, the alignment of the phototransistors with the object in conjunction with the embodiment of FIG. 1 means that both the object and the phototransistors that are in alignment with the object are generally spaced from the surface on which the monitoring system is positioned by the same distance or offset. The remainder of the phototransistors of the respective photoreceiver receive much brighter light, i.e., light having a greater intensity, than the shadowed phototransistors since the light curtain generated by the corresponding phototransmitter has not been blocked by the object passing therethrough. See, for example, FIG. 4 in which the shadowed photoreceivers are matched.

During the period in which the phototransistors are activated, each phototransistor of every respective photoreceiver 24 repeatedly or continuously provides an output signal indicative of the light that is currently being captured to, for example, the controller 16. By comparing the signals provided by the phototransistors of a respective photoreceiver, the shadowed phototransistors can be identified, such as by the controller, and the corresponding position of the object at that instance in time can be determined as a result of the alignment between the object and the shadowed phototransistors. In order to avoid errantly considering a phototransistor to have been shadowed in instances in which the phototransistor is only partially shadowed, such as by an insect flying through the light curtain, the controller can define a threshold value with a phototransistor only being considered to have been shadowed if the output signal provided by the phototransistor is less than the threshold value. Additionally, the controller can determine the time at which the object was located at that position by determining the time (with reference to either an internal or external clock) at which a predetermined portion of the object, such as the leading edge of a golf ball, was detected by the respective photoreceiver. By analyzing the outputs provided by the phototransistors of each photoreceiver over time, the controller can determine the position of the golf ball at each of a number of different instances in times.

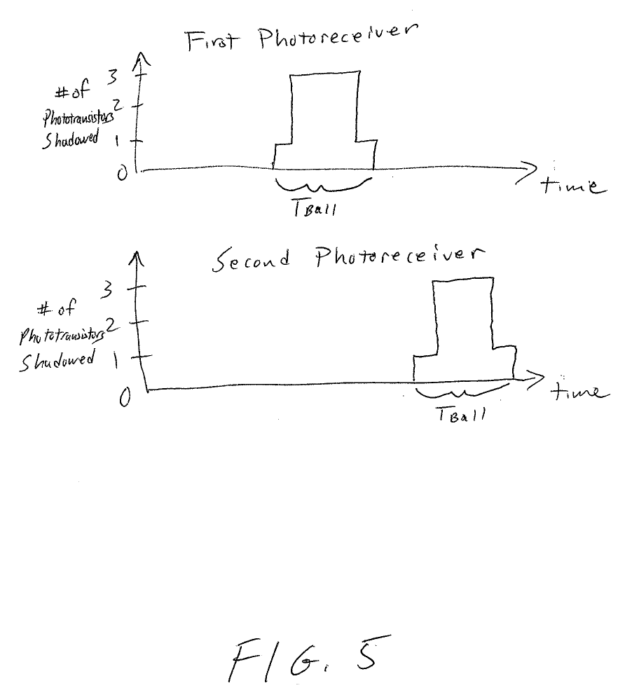

By way of example, FIG. 5 graphically depicts the output signals provided by first and second photoreceivers over time. In the graphical depiction of FIG. 5, the number of phototransistors that are shadowed at each moment in time is depicted. As shown during the time period designated T_{Ball}, a signal phototransistor is initially shadowed indicating shadowing provided by the leading edge of the ball. Thereafter, three phototransistors are shadowed as shown in FIG. 4 while the medial portion of the ball passes through the light curtain followed by, again, only a single shadowed phototransistor as created by the trailing edge of the ball. As will be apparent from a comparison of the output signals provided by the first and second phototransistors, the ball first passes through the light curtain received by the first phototransistor prior to passing through the light curtain received by the second phototransistor.

In a relatively simple exemplary embodiment in which the illumination component 12 includes first and second phototransmitters and the reception component shown schematically in FIG. 4 includes first and second photoreceivers, the controller 16 can determine the location L1 of a golf ball at the first time T1 based upon the shadowed phototransistors of the first photoreceiver and the location L2 of a golf ball at the second time T2 based upon the shadowed phototransistors of the second photoreceiver.

Based upon the position of the object at different instances in time, the controller 16 can determine various parameters associated with the motion of the object including the speed of the object and the angle of motion, such as the launch angle, of the object. In this regard, the speed of the object can be determined as follows:

v=ΔPosition/time

wherein ΔPosition is the change in position of the object and time is the time elapsed for the object to make the change in position. In the embodiment described above and illustrated schematically in FIG. 4, ΔPosition can be defined as:

ΔPosition=(Spacing²+ΔHeight²)^{1/2}

wherein Spacing is the predefined spacing in the direction X between the pair of photoreceivers in question while ΔHeight is the change in position of the object in a direction perpendicular to the surface upon which the monitoring system 10 is positioned. For example, the change in position may be the change in height or altitude of the object between the position of the object detected by the first and second photoreceivers. In this regard, the controller can determine the position of the object based upon the lower edge of the object (i.e., the edge of the object closest to the surface upon which the monitoring system is positioned), the upper surface of the object (i.e., the surface of the object farthest from the surface upon which the monitoring system is positioned) or the center of the object (i.e., the average between the upper and lower surfaces of the object).

Additionally, the controller 16 can determine the launch angle as follows:

Θ=tan⁻¹(ΔHeight/Spacing)

Based upon the speed and launch angle, the controller 16 can also determine other parameters, such as the distance that the object will travel and, in instances in which the object is a golf ball, the speed of the club head upon impact with the golf ball.

The monitoring system 10 can also include a display 26, typically driven by the controller 16, to present to the user the parameters that have been determined by the controller, such as the ball speed and launch angle. As such, a golfer can hit the golf shot and then merely glance at the display carried by one of the components of the monitoring system, such as the reception component 14, to determine the ball speed and launch angle. Additionally or alternatively, the monitoring system can include a memory device 28, such as within the reception component, for storing the parameters determined by the computer for subsequent communication, e.g., download, to an off-board computing device, such as a personal computer, for analysis or for comparative purposes over some period of time. By providing such quick feedback of the parameters associated with the golf shot, a golfer can learn and understand the way in which changes in their golf swing or setup affects the resulting shot. However, the monitoring system can be quite economical, especially in comparison to conventional launch monitors that employ more complex imaging systems.

Moreover, the monitoring system 10 is quite portable and lightweight and can be easily carried to a driving range or other facility at which it is desirable to monitor the motion of an object. The reception component 14 and, in particular, the photoreceivers 24 may be designed to be sufficiently large, e.g., have a sufficient height in the direction upward from or perpendicular to the surface on which the monitoring system is positioned, to detect golf balls having a wide range of launch angles, including both shallow and steep launch angles. In order to enhance the portability of the monitoring system, however, the illumination component 12 and, in particular, the phototransmitters 18 can be smaller in the direction upward from or perpendicular to the surface on which the monitoring system is positioned than the corresponding photoreceivers. However, the LEDs that comprise the phototransmitters of one embodiment can be angled to produce a light curtain that fans upward and downward in the orientation depicted in FIG. 1 so as to illuminate the entirety of the corresponding photoreceiver, thereby generating a relatively tall light curtain in order to capture balls having a wide range of launch angles.

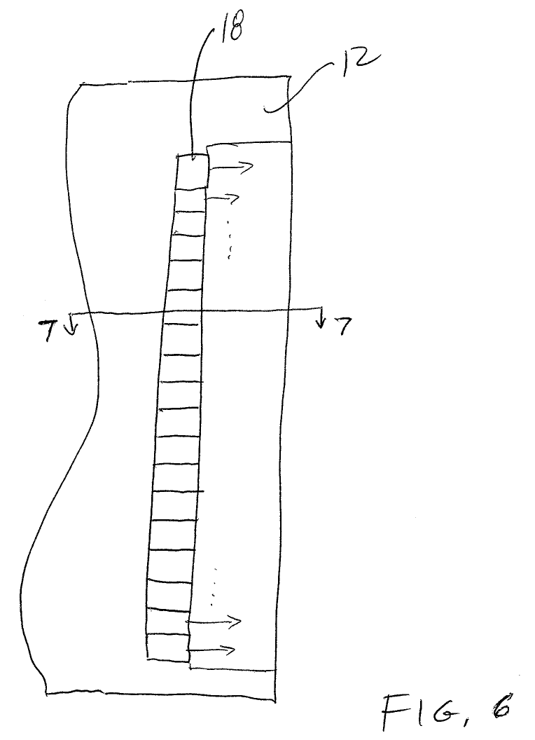

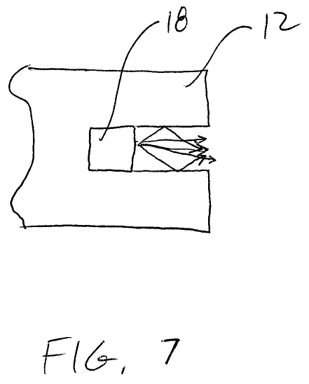

As described above, the light curtain generated by a phototransmitter 18 preferably only illuminates and is captured by a single corresponding photoreceiver 24 since the results and the resolution of the results provided by the monitoring system 10 would otherwise be less reliable. In the embodiment in which each phototransmitter is comprised of an array of LEDs, it is noted that the LEDs typically include a lens for limiting the dispersion angle of the light generated by the LEDs, such as to a half angle of ten degrees or the like. While the lenses associated with the LEDs are helpful in limiting dispersion, the spacing between the illumination and reception units, such as a spacing of three feet in one example, is such that the photoreceivers and, correspondingly, the phototransmitters had to be spaced apart from one another by a larger distance than is desirable since such greater spacing generally increases the overall size of the monitoring system and hinders its portability. As such, the monitoring system of one embodiment is designed such that each phototransmitter, such as each array of LEDs, is recessed relative to the housing of the illumination component 12 by a predetermined distance as shown in FIGS. 6 and 7. As a result of this recessing of the phototransmitters, a channel is created between the phototransmitters and the face of the housing of the illumination component. As such, the most divergent components of the light emitted by the phototransmitter is refracted and/or reflected from the portions of the housing that define the channel as shown in FIG. 7, thereby decreasing the overall divergence of the light produced by the phototransmitter and permitting the photoreceivers and, correspondingly, the phototransmitters to be spaced more closely together. While the phototransmitters can be recessed by various distances, the phototransmitters of one embodiment are recessed by between about one inch and three inches, such as about two inches, from the face of the housing of the illumination component that faces the reception component.

The photoreceiver 24 can also be recessed relative to its housing, such as by about two inches in one embodiment, in order to prevent the receiver elements from capturing all of the ambient light. Additionally, the controller 16 may be configured to automatically reduce the output signals provided by the receiver elements by a predetermined amount in order to account for the likely reception of some ambient light by the receiver elements. In this regard, the predetermined amount by which the output signals are reduced is typically established to substantially equal the output signals that would be produced by the receiver elements in response to ambient light without any illumination from the phototransmitters 18.

While the monitoring system 10 has been described relative to an embodiment having an illumination component 12 and a separated reception component 14, the monitoring system of another embodiment can include only a single component that includes all of the elements described above and illustrated in FIG. 3. In this embodiment, the monitoring system does not rely upon transmission of a light curtain from a phototransmitter to a corresponding photoreceiver with a portion of that light curtain being blocked by a passing object, but instead relies upon the reflection of some of the optical signals by an object passing through a light curtain. As such, the phototransmitters of this embodiment would generate a light curtain. An object, such as a golf ball, passing through the light curtain would cause that portion of the light curtain that encounters the object to be reflected. The corresponding photoreceiver would then receive optical signals with those phototransistors that receive optical signals of greater intensity being considered to be in alignment with the object as a result of the reflection of the optical signals, while those phototransistors that detect little or no illumination are indicative of further transistors that are out of alignment with the object. By operating in the reflection mode as described above, the monitoring system can include only a single component, thereby further increasing its portability and simplifying its setup and alignment at a driving range or elsewhere.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A monitoring system comprising:
a phototransmitter for providing illumination of a portion of a space through which an object will pass;
a plurality of photoreceivers spaced apart from one another, wherein each photoreceiver comprising a plurality of receiver elements, and wherein the phototransmitter and the plurality of photoreceivers are configured to establish a respective light curtain associated with each photoreciver;
a triggering mechanism configured to cause the phototransmitter to provide the illumination in response to a predefined triggering event; and
a controller configured to analyze output signals provided by the receiver elements of the plurality of photoreceivers and to detect the object in relation to a respective photoreceiver based upon the output signals provided by the receiver elements of the respective photoreceiver, wherein the controller is also configured to determine a parameter associated with a flight of the object through the space based upon detection of the object in relation to each of a plurality of the photoreceivers.

2. A monitoring system according to claim 1 further comprising a plurality of phototransmitters spaced apart from one another.

3. A monitoring system according to claim 2 wherein each photoreceiver is paired with and illuminated by a different respective phototransmitter such that a light curtain is established between each paired phototransmitter and photoreceiver.

4. A monitoring system according to claim 1 further comprising a housing in which the plurality of photoreceivers are disposed, wherein the photoreceivers are recessed relative to the housing.

5. A monitoring system according to claim 1 wherein the triggering mechanism comprises a high pass filter.

6. A monitoring system according to claim 1 wherein the phototransmitter ceases to provide the illumination following lapse of a predetermined amount of time from the predefined triggering event.

7. A monitoring system according to claim 1 further comprising a housing in which the phototransmitter is disposed, wherein the phototransmitter comprises a plurality of illumination elements recessed within the housing.

8. A monitoring system according to claim 1 wherein the controller is further configured to determine a difference in time at which the object is detected in relation to different ones of the plurality of photoreceivers.

9. A monitoring system according to claim 1 wherein the controller is further configured to ignore the output signals provided by the receiver elements of the respective photoreceiver that fail to satisfy a predefined threshold.

10. A monitoring system according to claim 1 further comprising:
an illumination component comprising a housing and the phototransmitter disposed within the housing; and
a reception component comprising a housing and the plurality of photoreceivers disposed within the housing,
wherein the illumination component and the reception component are configured to be spaced apart from one another such that the object will pass therebetween, and
wherein the controller is configured to detect the object in relation to a respective photoreceiver based upon a shadow created by the object upon one or more receiver elements of the respective photoreceiver.

11. A monitoring system according to claim 1 further comprising a housing in which the phototransmitter and the plurality of photoreceivers are disposed, wherein the controller is configured to detect the object in relation to a respective photoreceiver based upon light reflected from the object that is captured by one or more receiver elements of the respective photoreceiver.

12. A method comprising:
illuminating a portion of a space through which an object will pass, wherein illuminating comprises initiating illumination of the portion of the space in response to a predefined triggering event;
detecting light with each of a plurality of spaced apart photoreceivers, wherein detecting light with a photoreceiver comprises detecting light with a plurality of receiver elements that comprise the photoreceiver, and wherein said illuminating and detecting establishes a plurality of light curtains with a respective light curtain associated with each photoreciver;
detecting the object in relation to a respective photoreceiver based upon output signals provided by the receiver elements of the respective photoreceiver; and
determining a parameter associated with a flight of the object through the space based upon detection of the object in relation to each of a plurality of the photoreceivers.

13. A method according to claim 12 wherein detecting light comprises detecting light with the plurality of photoreceivers which are recessed within a housing.

14. A method according to claim 12 further comprising filtering the audible signals prior to initiating illumination.

15. A method according to claim 12 further comprising ceasing the illumination following lapse of a predetermined amount of time from the predefined triggering event.

16. A method according to claim 12 further comprising determining a difference in time at which the object is detected in relation to different ones of the plurality of photoreceivers.

17. A method according to claim 12 wherein detecting the object comprises ignoring the output signals provided by the receiver elements of the respective photoreceiver that fail to satisfy a predefined threshold.

18. A method according to claim 12 wherein the plurality of photoreceivers are spaced from a source of illumination such that the object will pass therebetween, and wherein detecting the object further comprises detecting the object in relation to a respective photoreceiver based upon a shadow created by the object upon one or more receiver elements of the respective photoreceiver.

19. A method according to claim 12 wherein the plurality of photoreceivers are positioned on the same side of the space as a source of illumination such that the object will pass to one side of both the plurality of photoreceivers and the source of illumination, and wherein detecting the object further comprises detecting the object in relation to a respective photoreceiver based upon light reflected from the object that is captured by one or more receiver elements of the respective photoreceiver.
